(19) United States
(12) Patent Application Publication
(10) Pub. No.: US 2020/0104028 A1
(43) Pub. Date: Apr. 2, 2020

(54) REALISTIC GUI BASED INTERACTIONS WITH VIRTUAL GUI OF VIRTUAL 3D OBJECTS

(71) Applicant: Nitin Vats, Bengaluru (IN)

(72) Inventor: Nitin Vats, Bengaluru (IN)

(21) Appl. No.: 16/350,071

(22) Filed: Aug. 22, 2018

(51) Int. Cl. G06F 3/0481; G06K 9/00; G06T 19/00; G06T 15/20; G06T 7/73; G06F 3/01; G06T 13/40

(52) U.S. Cl. CPC G06F 3/04815; G06K 9/00671; G06T 19/006; G06T 13/40; G06T 7/74; G06F 3/011; G06T 15/205

(57) ABSTRACT

A method for realistically interacting with a 3D model of an object in 3D computer graphics environment, wherein the displayed 3D model is capable of performing user controlled interaction and having atleast one virtual interactive display mimicking an interactive display of the object, the method includes:
receiving an input for interaction on 3D model
if the interaction input is provided in a region of virtual interactive display,
then the interaction input is applied to a graphical user interface of this virtual interactive display only, while the 3d model or its part/s will be unable to receive this input for interaction in this region whereas the virtual interactive display is in any orientation or perspective in synchronize with the 3d model;
processing the interaction input and producing
Corresponding change in multimedia on virtual interactive display, or
performing user controlled interaction in 3d model or its part/s or change in multimedia on virtual interactive display, or combination thereof, if the particular input on the graphical user interface of virtual interactive surface is programmed to provide input for user controlled interaction of 3d model or its part/s;

Wherein user controlled interaction comprises interacting with atleast the 3D model as a whole or its part/s to perform any change in the 3D model as a whole or its part/s or a view of the 3D model representing output of the interaction.

### FIELD OF INVENTION

The invention relates to simulating realistic controls in 3D virtual objects. More specifically, the invention relates to interactions with virtual GUI of virtual 3D objects representing interaction with GUI display of real object

### BACKGROUND

In growing trends toward online buying of products, visualization and functionality testing of products in real life scenario has become need of the hour. Generally, as of now the products are shown as 2-D images, where these images are captured to just show the prospective buyer various views of the products, and most of things are left to the imagination of the buyer. For functionality testing, the only allowable way on these websites are the product specification write-up, or to the best, they are left to identify functionality through various testimonials of other users of the same product which are posted on these websites. However, these are still away from the real life experience of the products. The product specifications generally are limited write-up which provide certain boundary conditions or best use cases, which are far away from real life scenario. If a buyer buys the product viewing such un-realistic 2-D images and product specification write-up, it results in a un-realistic imagination of the user, which generally results in a unsatisfied buyer.

To deal with such scenario, few portals allow showing up some 3-Dimensional images with short videos or animations of the product. Such short videos, do help a buyer to understand the functional understanding of the product, however they are still far away from real life experience. One such scenario is disclosed in US20080012863 A1, where a system and method displays a virtual, three-dimensional view of at least one product on a display system, selects at least one action with the virtual, three-dimensional view of the product, and displays a three-dimensional animation of the selected action with the product on the display system. However, playing a three-dimensional animation do not provides for a real life experience of controlling and interacting with the product. Real life experience is largely unfulfilled in case of GUI display based products, where the functionality can be tested by interaction or using controls to the GUI of the product.

The object of the invention is to simulate realistic interaction with three-dimensional GUI of 3D virtual objects

### SUMMARY

The object of the Invention is achieved by a method for realistically interacting with a 3D model of an object in 3D computer graphics environment according to claim 1. The displayed 3D model is capable of performing user controlled interaction and having atleast one virtual interactive display mimicking an interactive display of the object

According to an embodiment of the method, the method includes:

receiving an input for interaction on 3D model

if the interaction input is provided in a region of virtual interactive display,

then the interaction input is applied to a graphical user interface of this virtual interactive display only, while the 3d model or its part/s will be unable to receive this input for interaction in this region whereas the virtual interactive display is in any orientation or perspective in synchronize with the 3d model;

processing the interaction input and producing
corresponding change in multimedia on virtual interactive display, or
performing user controlled interaction in 3d model or its part/s or change in multimedia on virtual interactive display, or combination thereof, if the particular input on the graphical user interface of virtual interactive surface is programmed to provide input for user controlled interaction of 3d model or its part/s;

Wherein user controlled interaction comprises interacting with atleast the 3D model as a whole or its part/s to perform any change in the 3D model as a whole or its part/s or a view of the 3D model representing output of the interaction.

According to another embodiment of the method, the method includes:

receiving an interaction input for 3D model or its part/s other than the virtual interactive display;

processing the interaction input;

displaying corresponding user controlled interaction output by the 3D model or its part/s, or multimedia change on the graphical user interface being displayed onto the virtual interactive display along with the user controlled interaction, if the interaction input on 3D model or its part/s is to control graphical user interface being displayed on the virtual interactive display.

According to yet another embodiment of the method, wherein the user controlled interaction of the 3D model or 3D model part/s comprises at least one of extrusive interaction for interacting with exterior region or parts of the 3D model, intrusive interactions for interacting with internal parts or interior region of the 3D model, a time bound change based interaction, or a real environment mapping based interaction, or combination thereof. The time bound changes refers to representation of changes in the 3D model demonstrating change in physical property of object in a span of time on using or operating of the object, and real environment mapping refers to capturing a real time environment, mapping and simulating the real time environment to create a simulated environment for interacting with the 3D model.

According to one embodiment of the method, wherein the 3D model comprises a lighting part, and the interaction input on the 3D model results in the user controlled interaction for showing lighting effect onto the lighting part of the 3D model.

According to another embodiment of the method, wherein the lighting effect is produced by the change in texture of lighting surface whereas the changed texture is a video.

According to yet another embodiment of the method, wherein the lighting effect is produced by changing the brightness or other environmental parameters to show the effect.

According to one embodiment of the method, wherein the 3D model comprises a camera related feature, and to receive the interaction input on the 3D model, and to display a real environment mapping interaction by capturing a real time environment using a video or image capturing feature of a user device on which the 3D model of the object is being displayed.

According to another embodiment of the method, wherein receiving the interaction input while the virtual interactive display is in any plane or orientation in synchronization with the 3D model.

According to yet another embodiment of the method, wherein the 3D model behave as a virtual machine running an operating system or software, and receiving the interaction input to interact with the operating system or the software.

According to one embodiment of the method, wherein the multimedia displayed on virtual interactive display shows graphics which have different Graphical User Interface or data in different layers or containers or real operating system or software.

According to another embodiment of the method, wherein the interactive virtual display shows and allows interaction to a browser running on the display which is connected through a network via network interface of an user device on which the 3D model is being displayed.

According to yet another embodiment of the method, wherein the interactive virtual display shows and enables interaction to a real software running on the display.

According to one embodiment of the method, wherein the interactive virtual display shows and enables interaction to a representation of real software or Operating System or Control panel as a layered 2D graphics interactive video, or it loads different layer in run time.

According to another embodiment of the method, wherein the interaction on the interactive virtual display shows 2D graphics or Software or real Operating System which is running on server and connected to user device via network whereas after getting user input the software process on server and transfer the current gui to the virtual interactive surface.

According to yet another embodiment of the method, wherein the 3D model comprises two or more virtual interactive display, and the interaction input on one of the virtual interactive display results in corresponding multimedia change onto the graphical user interface of other virtual interactive display/s.

### BRIEF DESCRIPTION OF DRAWINGS

FIG. 1 illustrates a block diagram of the system implementing the invention.

FIG. 2 illustrates multiple GUI based objects using same backend operating system

FIG. 3(a)-3(c) illustrates multiple operating system compatible with same GUI based virtual 3D object.

FIG. 4(a)-4(j) illustrates Bluetooth data transfer between virtual mobile phone devices by interacting with GUI of both the virtual mobile phones

FIG. 5(a)-5(d) illustrates using an app of “Torch” by interacting with GUI of a mobile phone device.

FIG. 6(a)-6(d) illustrates capturing of an image by interacting with GUI of a virtual 3D camera.

FIG. 7(a)-7(c) illustrates capturing of an image of an in-screen object by interacting with camera functionality virtual mobile phone displayed on GUI of the virtual mobile phone.

FIG. 8(a)-8(d) illustrates online video streaming onto a virtual 3D mobile device by interacting with GUI of the virtual 3D mobile phone device.

FIG. 9(a)-9(c) illustrates functioning of a chat application onto the virtual 3D mobile device by interacting with GUI of the 3D virtual mobile phone device.

FIG. 10(a)-10(c) illustrates elongating and shortening of lens length of a virtual camera having a graphical user interface for elongating and shortening of the lens length.

FIG. 11 illustrate the system diagram

FIG. 12 illustrate the interaction of 3D model of mobile and its virtual interactive display

### DETAILED DESCRIPTION

The invention is described according to one of the embodiment as follows:

A computer implemented method for enabling realistic interactions with the virtual GUI of 3D models of objects the steps are as follows;
1. presenting a first view of at least one 3D model of an object using 3D model data and virtual GUI data.
2. Receiving an input related to an user interaction made onto the graphical user interface of the 3D model
3. A corresponding response is invoked using the input.
4. In response to the invoking, the corresponding response is rendered as corresponding change in 3D model and/or its virtual GUI display using virtual GUI data and/or 3D model data.

The virtual GUI data defining graphical representation of a graphical user interface of display of the object and responses to interactions to the graphical user interface. The Virtual GUI data includes texture, images, video, audio, animation or user controlled interactive animation. The texture includes textures obtained from photographs, video, color or images.

Video is used as texture in the 3D model only for that surface/s which corresponds to functioning part such as light-emitting parts in the real object. The use of video enhances reality in displaying dynamic texture changes for function part for lighting effect (one of extrusive and intrusive interactions). Multiple textures pre-calibrated on 3D model UV layouts can be stored as texture data for one/same surface, which are called for or fetched dynamically during the user-controlled interactions.

The response of interaction on virtual GUI is defined by the change in graphics in virtual GUI of Virtual 3D object with or without sound. It also includes the movement of part/s of 3d object along with the change in graphics of Virtual GUI with or without sound. If more than one virtual 3D objects are connected through virtual network in 3d computer graphics environment then response includes the change in graphics of virtual GUIs and part/s with or without sound of virtually connected 3d models. Response on virtual GUI includes showing some of the properties of system on which 3D model is processing such as time which may be same as in system in real time and/or can access internet and open sites in virtual GUI.

The responses to the interaction to the virtual GUI of the 3D model can be soft response, as well as, mechanical response. The soft responses are changes into the virtual GUI happening due to the interactions to the virtual GUI of the 3D model. One example of soft response is unlocking of the GUI of a virtual mobile phone, where unlocking interaction to the graphical user interface results in change of screen graphics of the graphical user interface from a locking screen graphics to a home screen graphics. While, the mechanical response relates to changes to a virtual hardware of the 3D model happening due to the interactions with the graphical user interface of the 3D model. One example of mechanical response is elongation and shortening of lens length of 3D model of a camera having graphical user interface for instructing to perform such function of shortening or elongating of lens length.

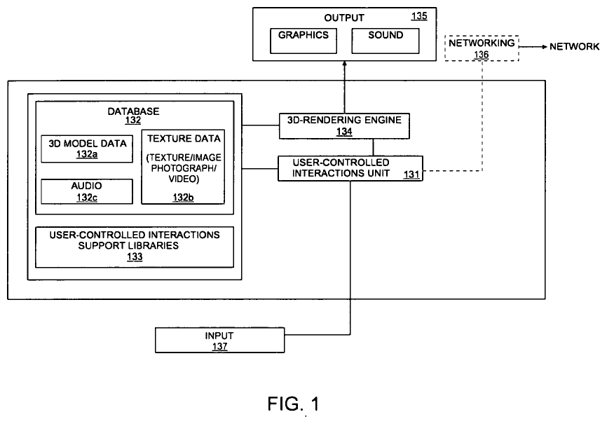

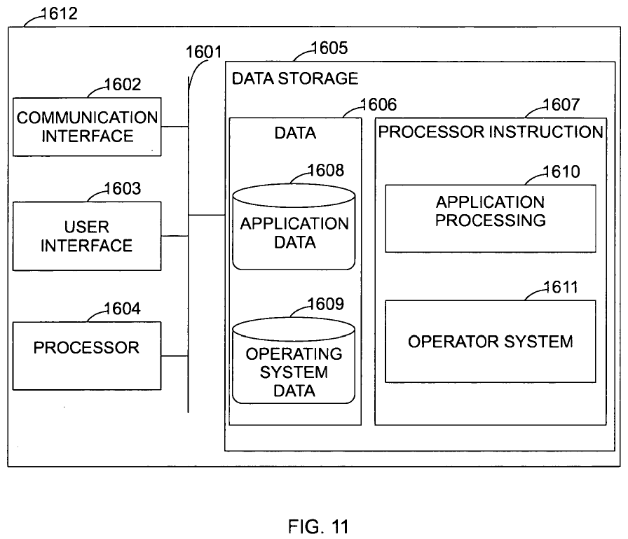

Explaining FIG. 1 and FIG. 11 together. FIG. 11 shows the system diagram. FIG. 11 is a simplified block diagram showing some of the components of an example client device 1612. By way of example and without limitation, client device is a any device, including but not limited to portable or desktop computers, smart phones and electronic tablets, television systems, game consoles, kiosks and the like equipped with one or more wireless or wired communication interfaces. 1612 can include memory interface, data processor(s), image processor(s) or central processing unit(s), and peripherals interface. Memory interface, processor(s) or peripherals interface can be separate components or can be integrated in one or more integrated circuits. The various components described above can be coupled by one or more communication buses or signal lines.

Sensors, devices, and subsystems can be coupled to peripherals interface to facilitate multiple functionalities. For example, motion sensor, light sensor, and proximity sensor can be coupled to peripherals interface to facilitate orientation, lighting, and proximity functions of the device.

As shown in FIG. 11, client device 1612 may include a communication interface 1602, a user interface 1603, and a processor 1604, and data storage 1605, all of which may be communicatively linked together by a system bus, network, or other connection mechanism.

Communication interface 1602 functions to allow client device 1612 to communicate with other devices, access networks, and/or transport networks. Thus, communication interface 1602 may facilitate circuit-switched and/or packet-switched communication, such as POTS communication and/or IP or other packetized communication. For instance, communication interface 1602 may include a chipset and antenna arranged for wireless communication with a radio access network or an access point. Also, communication interface 1602 may take the form of a wireline interface, such as an Ethernet, Token Ring, or USB port. Communication interface 1602 may also take the form of a wireless interface, such as a Wifi, BLUETOOTH®, global positioning system (GPS), or wide-area wireless interface (e.g., WiMAX or LTE). However, other forms of physical layer interfaces and other types of standard or proprietary communication protocols may be used over communication interface 102 Furthermore, communication interface 1502 may comprise multiple physical communication interfaces (e.g., a Wifi interface, a BLUETOOTH® interface, and a wide-area wireless interface).

Wired communication subsystems can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The device may include wireless communication subsystems designed to operate over a global system for mobile communications (GSM) network, a GPRS network, an enhanced data GSM environment (EDGE) network, 802.x communication networks (e.g., WiFi, WiMax, or 3 G networks), code division multiple access (CDMA) networks, and a Bluetooth™ network. Communication subsystems may include hosting protocols such that the device may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

User interface 1603 may function to allow client device 1612 to interact with a human or non-human user, such as to receive input from a user and to provide output to the user. Thus, user interface 1603 may include input components such as a keypad, keyboard, touch-sensitive or presence-sensitive panel, computer mouse, joystick, microphone, still camera and/or video camera, gesture sensor, tactile based input device. The input component also includes a pointing device such as mouse; a gesture guided input or eye movement or voice command captured by a sensor, an infrared-based sensor; a touch input; input received by changing the positioning/orientation of accelerometer and/or gyroscope and/or magnetometer attached with wearable display or with mobile devices or with moving display; or a command to a virtual assistant.

Audio subsystem can be coupled to a speaker and one or more microphones to facilitate voice-enabled functions, such as voice recognition, voice replication, digital recording, and telephony functions.

User interface 1603 may also be configured to generate audible output(s), via a speaker, speaker jack, audio output port, audio output device, earphones, and/or other similar devices, now known or later developed. In some embodiments, user interface 1603 may include software, circuitry, or another form of logic that can transmit data to and/or receive data from external user input/output devices. Additionally or alternatively, client device 112 may support remote access from another device, via communication interface 1602 or via another physical interface.

I/O subsystem can include touch controller and/or other input controller(s). Touch controller can be coupled to a touch surface. Touch surface and touch controller can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface. In one implementation, touch surface can display virtual or soft buttons and a virtual keyboard, which can be used as an input/output device by the user.

Other input controller(s) can be coupled to other input/control devices, such as one or more buttons, rocker switches, thumb-wheel, infrared port, USB port, and/or a pointer device such as a stylus. The one or more buttons (not shown) can include an up/down button for volume control of speaker and/or microphone.

The computer system can include clients and servers. A client and server are generally remote from each other and typically interact through a network. The relationship of client and server arises by virtue of computer programs running on the respective computers and having a client-server relationship to each other.

One or more features or steps of the embodiments can be implemented using an Application Programming Interface (API). An API can define on or more parameters that are passed between a calling application and other software code (e.g., an operating system, library routine, function) that provides a service, that provides data, or that performs an operation or a computation.

Processor 1604 may comprise one or more general-purpose processors (e.g., microprocessors) and/or one or more special purpose processors (e.g., DSPs, CPUs, FPUs, network processors, or ASICs).

Data storage 1605 may include one or more volatile and/or non-volatile storage components, such as magnetic, optical, flash, or organic storage, and may be integrated in whole or in part with processor 1604. Data storage 1605 may include removable and/or non-removable components.

In general, processor 1604 may be capable of executing program instructions 1607 (e.g., compiled or non-compiled program logic and/or machine code) stored in data storage 1505 to carry out the various functions described herein. Therefore, data storage 1605 may include a non-transitory computer-readable medium, having stored thereon program instructions that, upon execution by client device 1612, cause client device 1612 to carry out any of the methods, processes, or functions disclosed in this specification and/or the accompanying drawings. The execution of program instructions 1607 by processor 1604 may result in processor 1604 using data 1606.

By way of example, program instructions 1607 may include an operating system 1611 (e.g., an operating system kernel, device driver(s), and/or other modules) and one or more application programs 1610 installed on client device 1612 Similarly, data 1606 may include operating system data 1609 and application data 1608. Operating system data 1609 may be accessible primarily to operating system 1611, and application data 1608 may be accessible primarily to one or more of application programs 1610. Application data 1608 may be arranged in a file system that is visible to or hidden from a user of client device 1612.

In one embodiment as shown in FIG. 1, a user controlled interaction unit 131 uses 3D model graphics data/wireframe data 132a, texture data 132b, audio data 132c along with user controlled interaction support libraries 133 to generate the output 135, as per input request for interaction 137, using rendering engine 134. The interaction for understanding the functionality is demonstrated by ordered operation/s of part/s of 3d model. Such functionalities are coded in sequential and or parallel fashion such as two or more functionality may merge together while it is requested and leave the few steps if required: Such functionalities are coded so that other kind of interaction may be performed simultaneously. User controlled interaction unit 131 use such coded functionalities to generate the required output 135.

Application Programs 1610 includes programs for performing the following steps, when executed over the processor:
generating and displaying a first view of the 3D model;
receiving an user input, the user input are one or more interaction commands;
identifying one or more interaction commands;
in response to the identified command/s, rendering of corresponding interaction to 3D model of object with or without sound output using texture data, computer graphics data and selectively using sound data of the 3D-model of object; and
displaying the corresponding interaction to 3D model,

As per another embodiment, a method for realistically interacting with a 3D model of an object in 3D computer graphics environment, wherein the displayed 3D model is capable of performing user controlled interaction and having atleast one virtual interactive display mimicking an interactive display of the object, the method comprising:
receiving an input for interaction on 3D model
if the interaction input is provided in a region of virtual interactive display,
then the interaction input is applied to a graphical user interface of this virtual interactive display only, while the 3d model or its part/s will be unable to receive this input for interaction in this region whereas the virtual interactive display is in any orientation or perspective in synchronize with the 3d model;
processing the interaction input and producing
   Corresponding change in multimedia on virtual interactive display, or
   performing user controlled interaction in 3d model or its part/s or change in multimedia on virtual interactive display, or combination thereof, if the particular input on the graphical user interface of virtual interactive surface is programmed to provide input for user controlled interaction of 3d model or its part/s;
Wherein user controlled interaction comprises interacting with atleast the 3D model as a whole or its part/s to perform any change in the 3D model as a whole or its part/s or a view of the 3D model representing output of the interaction.

Application program 1610 further includes a set of system libraries as shown by user controlled interaction support libraries, comprises functionalities for:
producing sound as per user-controlled interaction;
animation of one or more parts in the 3D model;
providing functionality of operation of electronic or digital parts in the displayed 3D model/s depending on the characteristics, state and nature of displayed object;
decision making and prioritizing user-controlled interactions response;
putting more than one 3D model/s in scene;
generating surrounding or terrain around the 3D model;
generating effect of dynamic lighting on the 3D model;
providing visual effects of color shades; and
generating real-time simulation effect;

Rendering of corresponding interaction to 3D model of object in a way for displaying in a display system made of one or more electronic visual display or projection based display or combination thereof.

In different embodiments, the virtual interactive display showcase the particular GUI layer of an interactive video, it can be a layer of GUI of a software or operating system.

The complete software of operating system can be load while loading of the 3d model. In other case, the software, interactive video or operating system can run at a different machine and its current layer can be displayed at virtual interaction display. It can take input and process the software or interactive video or operating system on different machine and transfer the image/multimedia of the changed GUI as per the user input on 3d model.

The 3d model with virtual interactive display can also behave as a virtual machine for testing software/operating systems

3d model can be programmed in such a way that the interaction on the GUI of virtual interaction display can output in generating an event which become the input for user controlled interaction on 3d model.
Vice versa the input on 3d model can generate an output which become an input for the change in GUI of virtual interactive display.

The GUI is interacted through the controls which are software components that a computer user interacts with through direct manipulation to read or edit information about an application. User interface libraries contain a collection of controls and the logic to render these. Each widget facilitates a specific type of user-computer interaction, and appears as a visible part of the application's GUI as defined by the theme and rendered by the rendering engine. The theme makes all widgets adhere to a unified aesthetic design and creates a sense of overall cohesion.

As per another embodiment; the application GUI layer receives an event from Operating System, then Application event controller delegates the event to respective handlers. If the component to which event is delegated is itself a complex component then it may further delegate the event processing.

Main Application's GUI layer handles the 3D interactions (rotation, zoom etc) wherein if the event is delegated to the virtual interactive display then virtual interactive display component takes over the inside interactions (scroll, App Icon click, or any other event interaction).

The even model works as:

1. Hardware generates an event and its driver sends the event to Operating System (Layer 1)
2. Operating System receives the event and delegates the event handling to subscribers (Layer 2)
3. Application receives an event and controller (control loop—Layer 3) delegates the handling to respective handlers, these handlers may be another control loop inside a component.
4. Finally the event gets handled at lowest level or the last logical layer of the application architecture.
5. IF event doesn't get handled then it is handled by the default handler at the OS level.

The 3d model can behave as a virtual machine as well whereas the virtual machine is an emulation of a computer system. Virtual machines are based on computer architectures and provide functionality of a physical computer.

The display system can be a wearable display or a non-wearable display or combination thereof. The non-wearable display includes electronic visual displays such as LCD, LED, Plasma, OLED, video wall, box shaped display or display made of more than one electronic visual display or projector based or combination thereof.

The non-wearable display also includes a pepper's ghost based display with one or more faces made up of transparent inclined foil/screen illuminated by projector/s and/or electronic display/s wherein projector and/or electronic display showing different image of same virtual object rendered with different camera angle at different faces of pepper's ghost based display giving an illusion of a virtual object placed at one places whose different sides are viewable through different face of display based on pepper's ghost technology.

The wearable display includes head mounted display. The head mount display includes either one or two small displays with lenses and semi-transparent mirrors embedded in a helmet, eyeglasses or visor. The display units are miniaturised and may include CRT, LCDs, Liquid crystal on silicon (LCos), or OLED or multiple micro-displays to increase total resolution and field of view.

The head mounted display also includes a see through head mount display or optical head-mounted display with one or two display for one or both eyes which further comprises curved mirror based display or waveguide based display. See through head mount display are transparent or semi transparent display which shows the 3d model in front of users eye/s while user can also see the environment around him as well.

The head mounted display also includes video see through head mount display or immersive head mount display for fully 3D viewing of the 3D-model by feeding rendering of same view with two slightly different perspective to make a complete 3D viewing of the 3D-model. Immersive head mount display shows 3d model in virtual environment which is immersive.

In one embodiment, the 3D model moves relative to movement of a wearer of the head-mount display in such a way to give to give an illusion of 3D model to be intact at one place while other sides of 3D model are available to be viewed and interacted by the wearer of head mount display by moving around intact 3D model.

The display system also includes a volumetric display to display the 3D model and interaction in three physical dimensions space, create 3-D imagery via the emission, scattering, beam splitter or through illumination from well-defined regions in three dimensional space, the volumetric 3-D displays are either auto stereoscopic or auto multiscopic to create 3-D imagery visible to an unaided eye, the volumetric display further comprises holographic and highly multiview displays displaying the 3D model by projecting a three-dimensional light field within a volume.

The input command to the said virtual assistant system is a voice command or text or gesture based command. The virtual assistant system includes a natural language processing component for processing of user input in form of words or sentences and artificial intelligence unit using static/dynamic answer set database to generate output in voice/text based response and/or interaction in 3D model.

Application program 1610 further includes a set of system libraries comprises functionalities for:

producing sound as per user-controlled interaction;

animation of one or more parts in the virtual model;

providing functionality of operation of electronic or digital parts in the displayed virtual model/s depending on the characteristics, state and nature of displayed object;

decision making and prioritizing user-controlled interactions response;

putting more than one virtual model/s in scene;

generating surrounding or terrain around the virtual model;

generating effect of dynamic lighting on the virtual model;

providing visual effects of colour shades; and

generating real-time simulation effect;

Other types of user controlled interactions are as follows:
interactions for colour change of displayed virtual model,
operating movable external parts of the virtual model,
operating movable internal parts of the virtual model,
interaction for getting un-interrupted view of interior or accessible internal parts of the virtual model,
transparency-opacity effect for viewing internal parts and different parts that are inaccessible,
replacing parts of displayed object with corresponding new parts having different texture,
interacting with displayed object having electronic display parts for understanding electronic display,
operating system functioning, vertical tilt interaction and/or horizontal tilt interaction,
operating the light-emitting parts of virtual model of object for functioning of the light emitting parts,
interacting with virtual model for producing sound effects,
engineering disintegration interaction with part of the virtual model for visualizing the part within boundary of the cut-to-screen, the part is available for visualization only by dismantling the part from the entire object,
time bound change based interactions to represent of changes in the virtual model demonstrating change in physical property of object in a span of time on using or operating of the object,
physical property based interactions to a surface of the virtual model, wherein physical property based interactions are made to asses a physical property of the surface of the virtual model
real environment mapping based interaction, which includes capturing an area in vicinity of the user, mapping and simulating the video/image of area of vicinity on a surface of the virtual model
addition based interaction for attaching or adding a part to the virtual model,
deletion based interaction for removing a part of virtual model,
interactions for replacing the part of the virtual model,
demonstration based interactions for requesting demonstration of operation of the part/s of the object which are operated in an ordered manner to perform a particular operation,
linked-part based interaction, such that when an interaction command is received for operating one part of virtual model, than in response another part linked to the operating part is shown operating in the virtual model along with the part for which the interaction command was received,
liquid and fumes flow based interaction for visualizing liquid and fumes flow in the virtual model with real-like texture in real-time
immersive interactions, where users visualize their own body performing user-controlled interactions with the virtual computer model.
   The displayed 3D model is preferably a life-size or greater than life-size representation of real object.

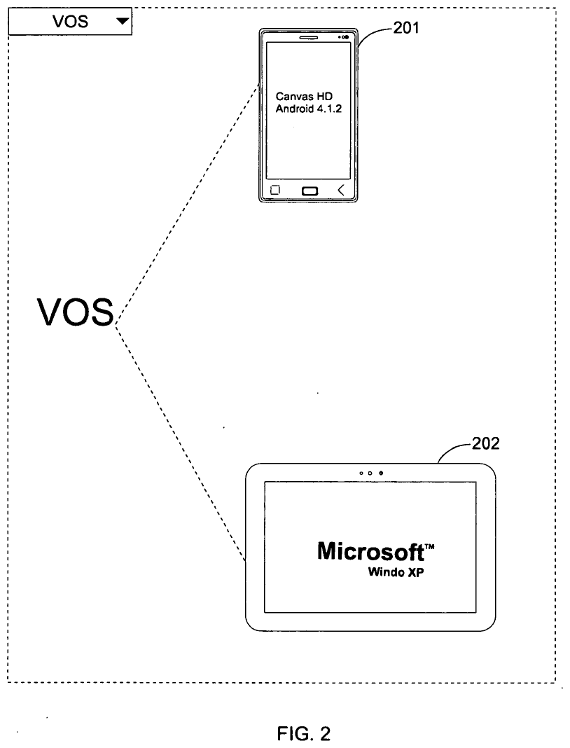

In FIG. 2, two types of 3D virtual devices, i.e., a mobile pad 201 and a mobile phone 202, are displayed which allows controls/interactions to GUI of 3D virtual devices. By interacting with various controls to be displayed on the GUI, functionality of the device is experienced. Both devices has some common behavior as they are loaded with a virtual operating system which is common to each of them. Both the devices shows change in there functionalities based on the virtual operating system loaded onto them. In both the 3D virtual mobile phone and the 3D virtual mobile pad, virtual controls for interacting with the mobile phone is provided onto the GUI of the mobile, so that an user directly interacts with the GUI of the mobile to experience functionality of the 3D virtual mobile.

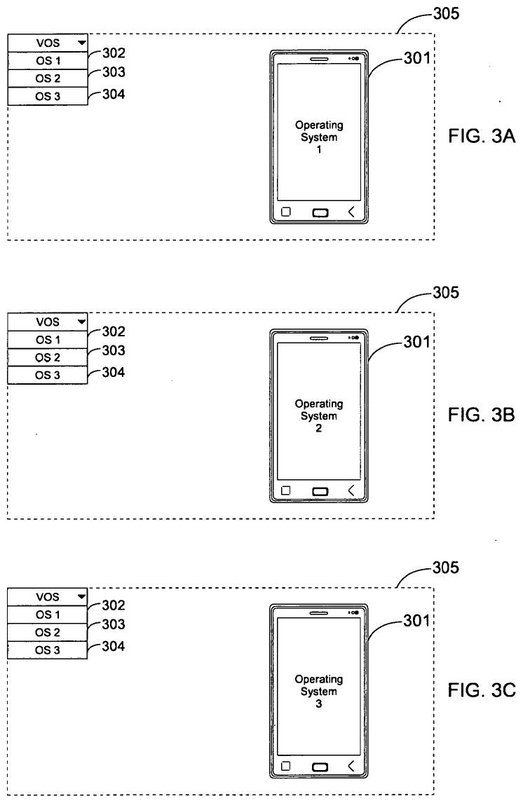

FIG. 3A-C shows a virtual 3D mobile phone 301 having option of instantaneously loading a virtual operating system from a group of three operating system 302, 303, 304. In FIG. 3A, a first operating system 302 is chosen, while in FIG. 3B a second operating system 303 is chosen, and in FIG. 3C a third based operating system 304 is chosen. It enables an user to test functionality of the mobile phone 301 with three different virtual operating system 302, 303, 304. Loading different operating systems 302, 303, 304 provides different characteristics of GUI 305 of the 3D virtual mobile phones 301. Also, each virtual operating system 302, 303, 304 provides with different experience with the GUI 305 of the 3D virtual mobile phone 301 and different controls may be required to interact with the GUI 305 of the 3D virtual mobile phone 301.

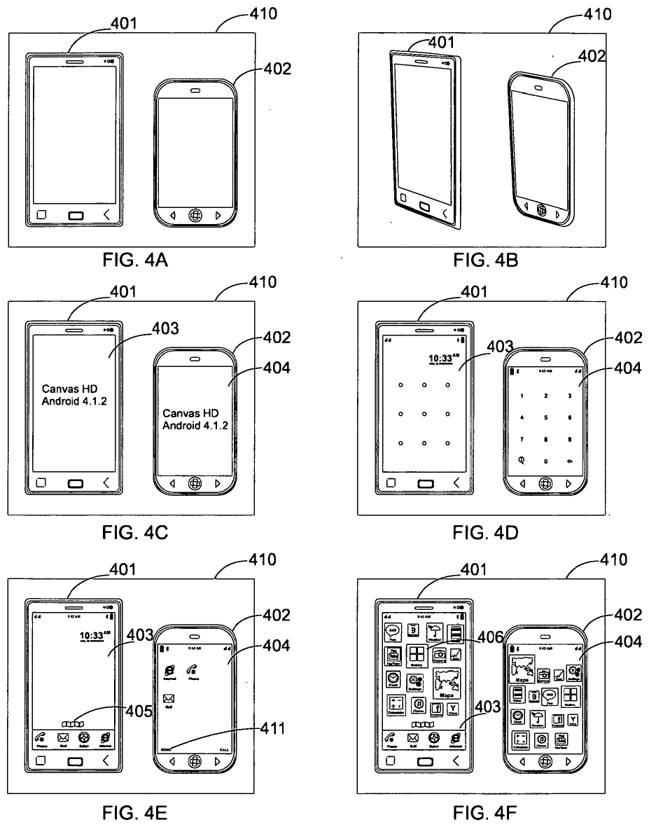

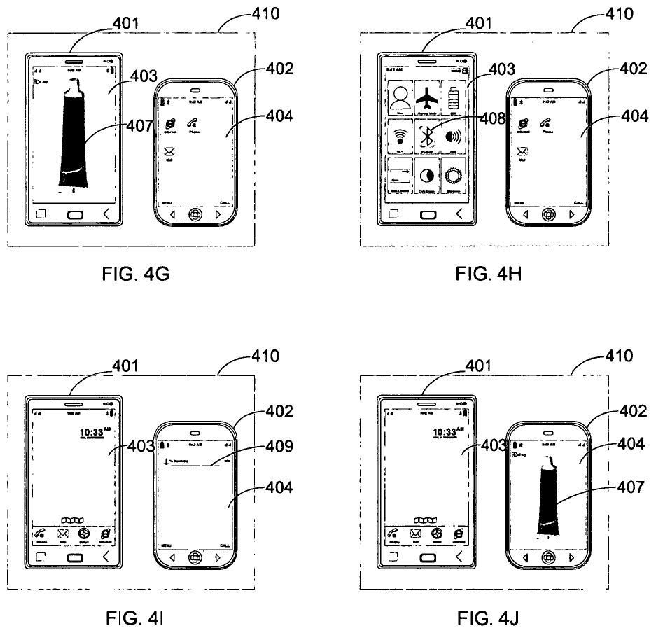

FIG. 4 A-J. shows bluetooth data transfer between virtual mobile phone devices 401, 402 by interacting with GUI 403, 404 of both the virtual mobile phones 401, 402 on a display device 410. FIG. 4A shows two virtual 3D mobile phones 401, 402 in two different three dimensional views. FIG. 4C-J shows various steps of transferring an image 407 from first virtual mobile phone 401 to the second virtual mobile phone 402. FIG. 4C shows loading of same virtual operating system “CANVAS HD 4.1.2” onto both the 3D virtual mobile phones 401, 402. FIG. 4D shows unlocking screens on GUI 403, 404 of both the 3D virtual mobile phones 401, 402 having different password entering patterns. An user interacts with GUI 403, 404 of the virtual 3D mobile phone 401, 402 to login into the Home screen of both the 3D virtual mobile phones 401, 402. FIG. 4E shows home screen on GUI 403, 404 of both the 3D virtual mobile phones 401, 402.

On home screen icons 405, 411 are shown for entering into the menu items provided in both the 3D virtual mobile phones 401, 402. The user clicks onto the icons 405, 411 shown onto virtual GUI 403, 404 of both the 3D virtual mobile phones 401, 402 and reach into menu items of both the 3D virtual mobile phones 401, 402 in FIG. 4F. In FIG. 4F, the menu items on the first virtual 3D mobile phone also shows a gallery icon 406, which is clickable to take the user to the image 407. FIG. 4 G shows an image 407 onto the GUI 403 of the first 3D virtual mobile phone 401 and home screen of the second 3D virtual mobile phone 402. When user interacts with GUI 403 of the first virtual 3D mobile phone 401 to send the image 407 to the second 3D virtual mobile phone 402, in FIG. 4H, the GUI 403 of the first 3D virtual mobile phone 401 shows up with various icons for options to send the image 407 to the second 3D virtual mobile phone 402. Once the user selects the icon 408 pertaining to bluetooth mode for sending the image 407 to second virtual 3D mobile phone 402, the image 407 is virtually sent to the second virtual 3D second mobile phone 402. It is shown in the FIG. 4I, where the GUI 403 of the first 3D virtual mobile phone 401 shows returning back to the home screen after sending the image 407 and GUI 404 of the second 3D virtual mobile phone 402 is shown with an icon 409 for downloading of the image 407. In FIG. 4J, the GUI 403 of the first virtual 3D mobile phone 401 is shown with the home screen and the second 3D virtual mobile phone 402 is shown with the downloaded image 407 on its GUI 404. From FIG. 4C-J, functionality of transferring data via Bluetooth virtually between virtual 3D mobile phone is vividly explained.

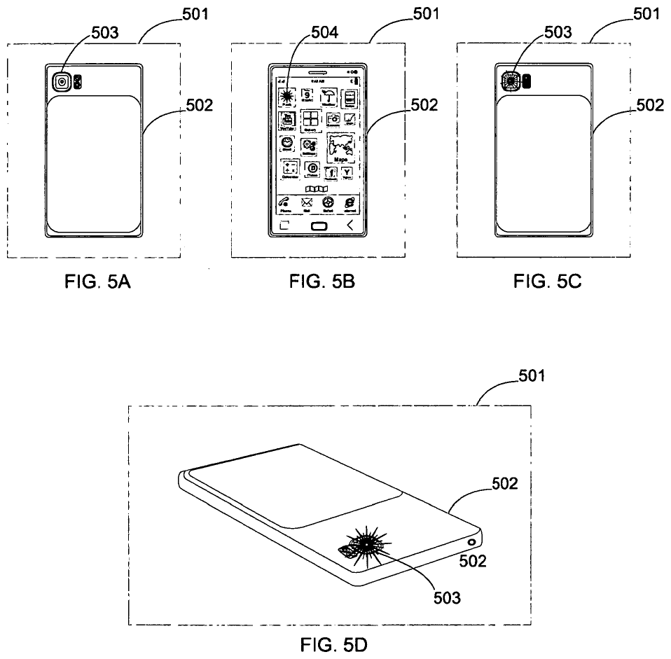

FIG. 5 A shows a 3D virtual mobile phone 502 having a flash light utility 503 on a display device 501. FIG. 5B shows GUI of the 3D virtual mobile phone 502 showing various apps displayed on the GUI along with the “Torch” app 504. The 3D virtual mobile phone is displayed on the display device 501. As the user selects the “Torch” app 504 and activates the lighting function provided in the app 504, the flash light from flash utility 503 of the 3D virtual mobile phone 502 is illuminated, as shown in FIG. 5C. FIG. 5D shows another three dimensional realistic view of the 3D virtual mobile phone 502 with flash light illuminated from flash utility 503. In both the figures, FIG. 5C, 5D, the 3D virtual mobile phones are displayed on the display device 501.

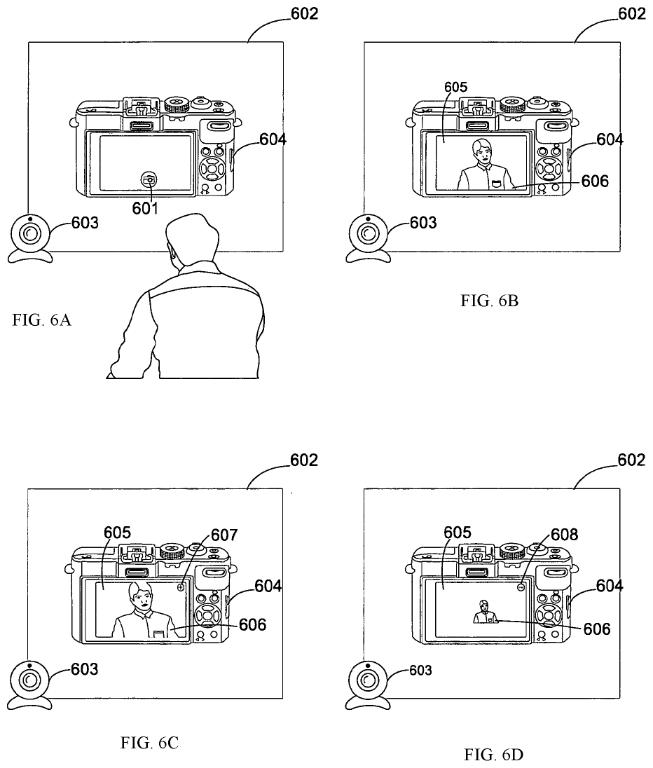

FIG. 6A shows an user sitting in front of a display 602 showing a 3D model 604 of a camera. The display 602 is functionally connected to a webcam 603 which allows clicking of an image of the user, when the user interacts GUI 605 of the 3D model 604 by clicking a capturing icon 601 shown on the GUI 605 of the 3D model 604 of the camera. For testing functionality of GUI 605 of the camera, the user clicks on the capturing icon 601 displayed on GUI 605 to capture an image 606 of himself. FIG. 6B shows captured image 606 of the user. The user can test all functionalities of the GUI of the camera, by interacting with GUI 605 of the 3D model 604 of the camera. In FIGS. 6C and 6D, further functionalities of zooming in and zooming out are shown by clicking on “−” and “+” icons 607, 608 shown on the GUI 605 of the 3D model 604 of the camera.

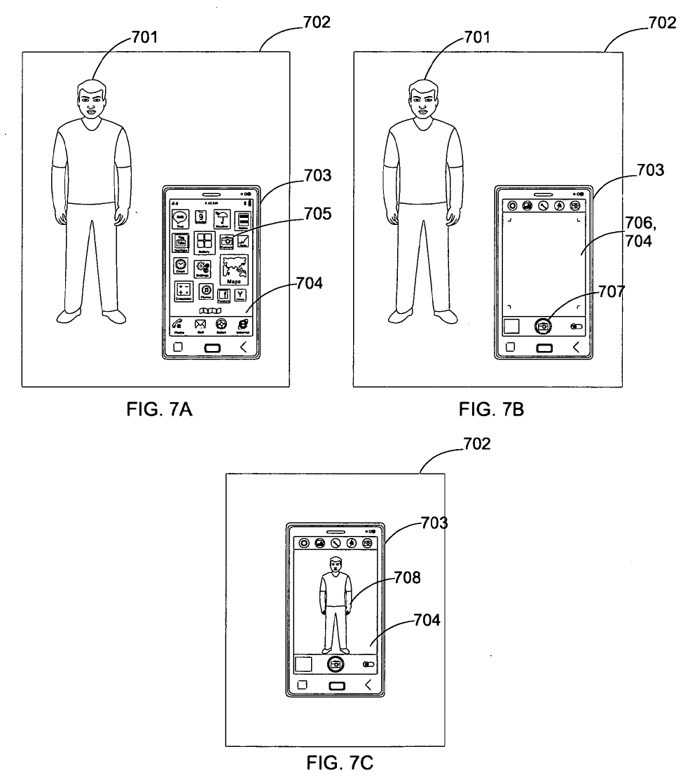

FIG. 7A-C. shows capturing of an image 708 of an in-screen object 701 by interacting with camera functionality 705 of a 3D virtual mobile phone 703 displayed on GUI 704 of the 3D virtual mobile phone 703, wherein the 3D virtual mobile phone 703 is displayed on a display device 702. Here in-screen object 701 is a person in standing posture. In FIG. 7A, a GUI 704 of the virtual 3D mobile phone 703 is shown along with the person 701. On the GUI 704, an initiating icon 705 to initiate a camera application is shown. Once an user clicks on to the initiating icon 705, the camera application is run as shown in FIG. 7B, where an image capturing area 706, an image capturing icon 707 and many other functionalities are presented. When the user clicks onto the image capturing icon 707, the image 708 of the person 701 is captured, as shown in FIG. 7C.

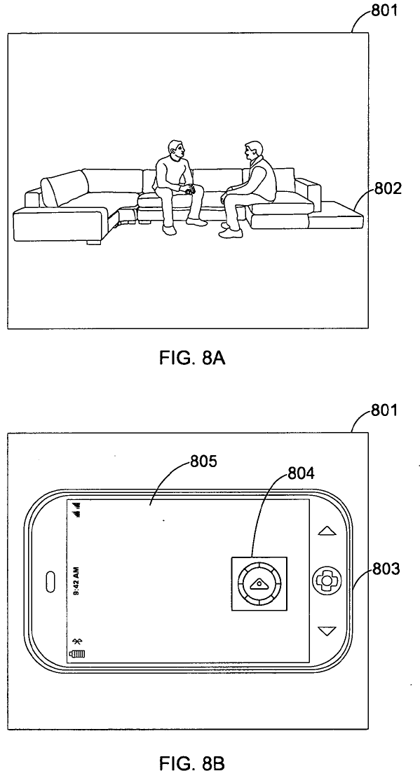

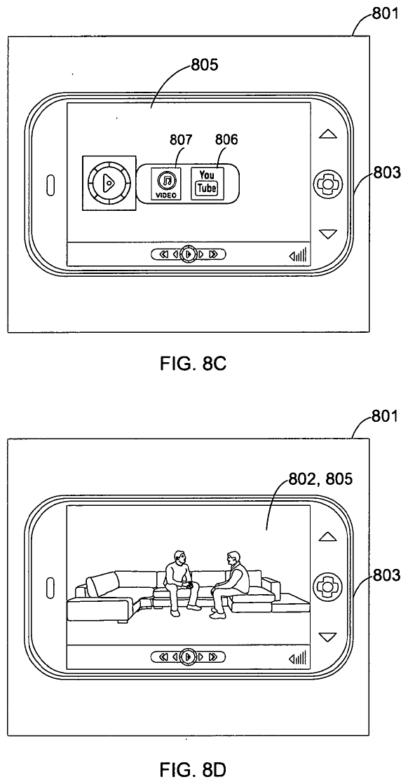

FIG. 8A-D. illustrates online video streaming onto a virtual 3D mobile phone 803 allowing interactions through GUI 805. FIG. 8A shows a video 801 currently running on a display 802. FIG. 8B shows a 3D virtual mobile phone 803 having an initiating icon 804 for running a video player, being displayed on the display 802. An user, if he wants to check running of the video 801 onto the 3D virtual mobile phone 803, the user clicks onto the initiating icon 804, the user is asked for source to run the video through sourcing icons 806, 807, a shown in FIG. 8C. One of the sources for running the video is through internet and another is from a local hard drive or temporary drive. When the user clicks onto any of the sourcing icons 806, 807, the video 801 is shown running onto the GUI 805 of the virtual 3D mobile phone 803, as shown in FIG. 8D. Through this the user can check functionality of the mobile phone, as well as, clarity of the video 801 when selected from different sources, even online video streaming on to the mobile phone.

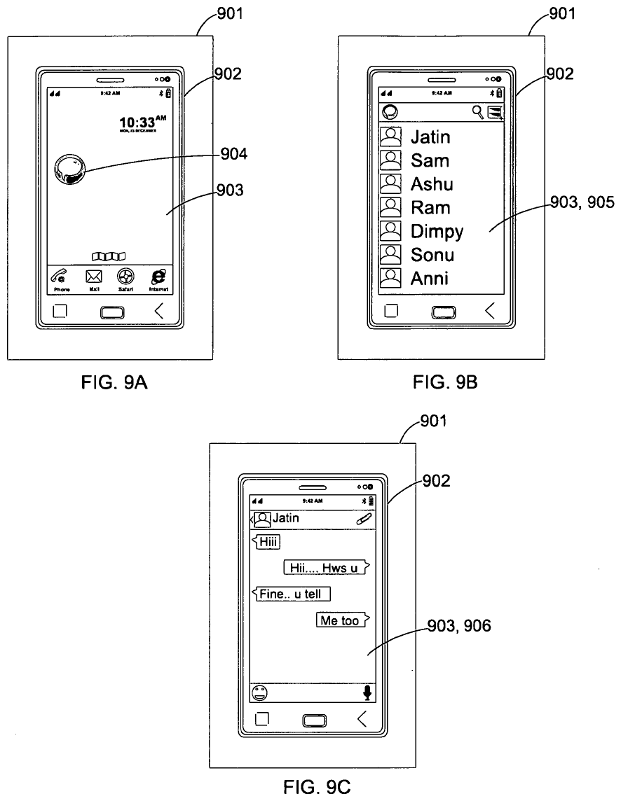

FIG. 9A-C. illustrates functioning of a chat application onto a 3D virtual mobile phone 902 by interacting with GUI 903 of the 3D virtual mobile phone device 902, wherein the 3D virtual mobile phone 902 is displayed on a display device 901. FIG. 9A shows an initiating icon 904 for initiating the chat application onto the GUI 903 of the 3D virtual mobile phone 902. When an user clicks onto the initiating icon 904, the chat applications starts running and opens a “Contact Page” 905 showing various contacts onto the GUI 903 of the 3D virtual mobile phone 902, as shown in FIG. 9B. Further, when user clicks onto one of the contacts, here “Jatin”, a chat page 906 opens up where the user can chat with the particular contact clicked onto the GUI 903 of the 3D virtual mobile phone 902, as shown in FIG. 9C.

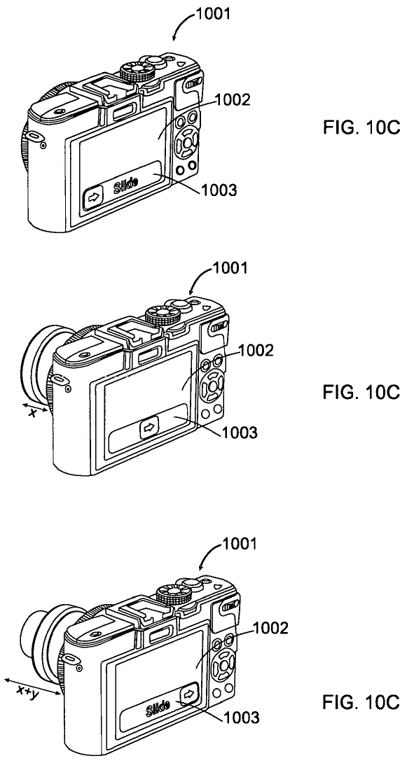

FIG. 10A-C illustrates elongating and shortening of lens length of a virtual camera 1001 having a graphical user interface 1002 for elongating and shortening of the lens length. In FIG. 10 A, a sliding bar 1003 is shown which has a slider 1004 for changing the lens length from minimum to maximum. The lens length in FIG. 10A is minimum and the slider is placed at minimum. In FIG. 10B, the lens length is changed from L to x by sliding the slider 1004 towards maximum, however still between the maximum and minimum, and in FIG. 10C, the lens length is further increased to x+y by moving the slider 1004 further towards the maximum. This is an example of mechanical change in 3D model of an object by interacting with the graphical user interface of the 3D model.

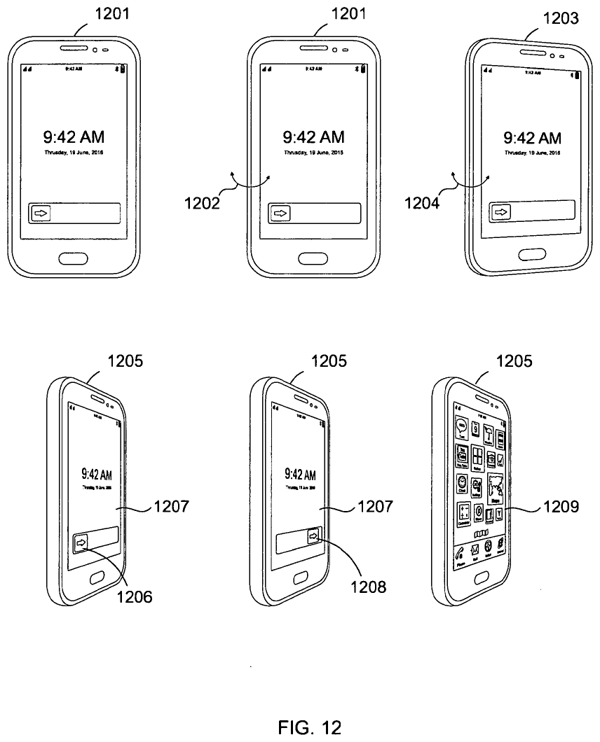

FIG. 12 illustrate the interaction of 3D model of mobile and its virtual interactive display. Virtual Mobile 1201 is shown. When the interaction of drag 1202 is applied on virtual mobile 1201 the 3d model take the command and it get rotated to a new orientation 1203. This is again given drag command 1204 and it further move to the orientation 1205. It shows the virtual interactive display 1207 and a swipe button 1206. When the drag command is given to swipe button on virtual interactive display the command don't give input to virtual 3d mobile but the virtual interactive display in interacted and the button reach in the position 1208 and therafter the gui of virtual mobile change to 1209 and it stays in the position 1205.

Here the 3d environment controllers take command in 3d graphics environment on 3d model while when command is given in the area of virtual interactive display the 2d environment controller takes the command in different sub layer of the application that's why the 3d mobile don't move even on drag.

In this case Application GUI layer receives an event from Operating System, then Application event controller delegates the event to respective handlers. If the component to which event is delegated is itself a complex component then it may further delegate the event processing.

Main Application's GUI layer handles the 3D interactions (rotation, zoom etc) wherein if the event is delegated to the virtual interactive display then virtual interactive display component takes over the inside interactions (scroll, App Icon click, or any other event interaction).

The even model works as:

1. Hardware generates an event and its driver sends the event to Operating System (Layer 1)
2. Operating System receives the event and delegates the event handling to subscribers (Layer 2)
3. Application receives an event and controller (control loop—Layer 3) delegates the handling to respective handlers, these handlers may be another control loop inside a component.
4. Finally the event gets handled at lowest level or the last logical layer of the application architecture.
5. IF event doesn't get handled then it is handled by the default handler at the OS level.

I claim:

1. A method for realistically interacting with a 3D model of an object in 3D computer graphics environment, wherein the displayed 3D model is capable of performing user controlled interaction and having atleast one virtual interactive display mimicking an interactive display of the object, the method comprising:
receiving an input for interaction on 3D model
if the interaction input is provided in a region of virtual interactive display,
then the interaction input is applied to a graphical user interface of this virtual interactive display only, while the 3d model or its part/s will be unable to receive this input for interaction in this region whereas the virtual interactive display is in any orientation or perspective in synchronize with the 3d model;
processing the interaction input and producing
Corresponding change in multimedia on virtual interactive display, or
performing user controlled interaction in 3d model or its part/s or change in multimedia on virtual interactive display, or combination thereof, if the particular input on the graphical user interface of virtual interactive surface is programmed to provide input for user controlled interaction of 3d model or its part/s;
Wherein user controlled interaction comprises interacting with atleast the 3D model as a whole or its part/s to perform any change in the 3D model as a whole or its part/s or a view of the 3D model representing output of the interaction.

2. The method according to the claim 1, comprising:
receiving an interaction input for 3D model or its part/s other than the virtual interactive display;
processing the interaction input;
displaying corresponding user controlled interaction output by the 3D model or its part/s, or multimedia change on the graphical user interface being displayed onto the virtual interactive display along with the user controlled interaction, if the interaction input on 3D model or its part/s is to control graphical user interface being displayed on the virtual interactive display.

3. The method according to claim 1, wherein the user controlled interaction of the 3D model or 3D model part/s comprises at least one of extrusive interaction for interacting with exterior region or parts of the 3D model, intrusive interactions for interacting with internal parts or interior region of the 3D model, a time bound change based interaction, or a real environment mapping based interaction, or combination thereof,
wherein the time bound changes refers to representation of changes in the 3D model demonstrating change in physical property of object in a span of time on using or operating of the object, and real environment mapping refers to capturing a real time environment, mapping and simulating the real time environment to create a simulated environment for interacting with the 3D model.

4. The method according to claim 1, wherein the 3D model comprises a lighting part, and the interaction input on the 3D model results in the user controlled interaction for showing lighting effect onto the lighting part of the 3D model.

5. The method according to claim 1, wherein the lighting effect is produced by the change in texture of lighting surface whereas the changed texture is a video.

6. The method according t claim 1, wherein the lighting effect is produced by changing the brightness or other environmental parameters to show the effect.

7. The method according to claim 1, wherein the 3D model comprises a camera related feature, and to receive the interaction input on the 3D model, and to display a real environment mapping interaction by capturing a real time environment using a video or image capturing feature of a user device on which the 3D model of the object is being displayed.

8. The method according to claim 1, wherein receiving the interaction input while the virtual interactive display is in any plane or orientation in synchronization with the 3D model.

9. The method according to claim 1, wherein the 3D model behave as a virtual machine running an operating system or software, and receiving the interaction input to interact with the operating system or the software.

10. The method according to claim 1, wherein the multimedia displayed on virtual interactive display shows graphics which have different Graphical User Interface or data in different layers or containers or real operating system or software.

11. The method according to claim 1, wherein the interactive virtual display shows and allows interaction to a browser running on the display which is connected through a network via network interface of an user device on which the 3D model is being displayed.

12. The method according to claim 1, wherein the interactive virtual display shows and enables interaction to a real software running on the display.

13. The method according to claim 1, wherein the interactive virtual display shows and enables interaction to a representation of real software or Operating System or Control panel as a layered 2D graphics interactive video, or it loads different layer in run time.

14. The method according to claim 1, wherein the interaction on the interactive virtual display shows 2D graphics or Software or real Operating System which is running on server and connected to user device via network whereas after getting user input the software process on server and transfer the current gui to the virtual interactive surface.

15. The method according to claim 1, wherein the 3D model comprises two or more virtual interactive display, and the interaction input on one of the virtual interactive display results in corresponding multimedia change onto the graphical user interface of other virtual interactive display/s.
